(19) United States
(12) Patent Application Publication
(10) Pub. No.: US 2019/0126667 A1
(43) Pub. Date: May 2, 2019

(54) PAINTER BOX SYSTEM

(71) Applicants: Danny Clarke, Langley (CA); Derrick Blasco, Surrey (CA)

(72) Inventors: Danny Clarke, Langley (CA); Derrick Blasco, Surrey (CA)

(21) Appl. No.: 15/802,433

(22) Filed: Nov. 2, 2017

(51) Int. Cl. B44D 3/04; B65D 21/02; B44D 3/02; B44D 3/12

(52) U.S. Cl. CPC B44D 3/04; B44D 3/126; B44D 3/02; B65D 21/0209

(57) ABSTRACT

A painter box system includes a housing having a top-surface, a first-wall, a second-wall, a third-wall, a fourth-wall, a base, a hollow inner volume, a plurality of legs, a paint-receptacle and a lid. The housing is defined by the top-surface, the first-wall the second-wall, the third-wall, the fourth-wall, the base, the hollow inner volume, the plurality of legs, and the paint-receptacle. The paint-receptacle is positioned and integral to the top-surface. The painter box system provides a work platform and supports paint within the paint-receptacle in a readily accessible position for use.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of painting accessories and more specifically relates to painting tools.

### 2. Description of Related Art

Many painters use paint rollers. A paint roller is a paint application tool used for painting large flat surfaces rapidly and efficiently. Paint rollers and paintbrushes can only hold a fixed amount of paint at a time. It is therefore necessary, when painting with a paintbrush or paint roller, to have a supply of paint accessible to the painter for replenishing the brush when required. This is often accomplished by placing a paint tray with paint near the area being painted or holding a can of paint with one hand and painting with the brush in the other. It is not always possible when working from one of these devices to have a convenient, stable surface to place the paint can on while painting. A suitable solution is desired.

U.S. Pat. No. 6,164,212 to Virgil T Haggard relates to a painter's mobil workstation. The described painter's mobil workstation includes a device which provides an upright standing enclosure having a top member 12 having multiple receptacles 34 for receiving various articles for painting such as paint brushes 24, rollers 13 and cans 11. The enclosure 10 is equipped with wheels 14 for portability and legs 16 with which to stand on. Foldable handles 18 are also provided for grasping while moving the enclosure 10. The side walls 28, 36, 38 and 40 of the enclosure are hingedly connected 42, 43 so that the walls fold inwardly for storing or transporting the device.

### BRIEF SUMMARY OF THE INVENTION

In view of the foregoing disadvantages inherent in the known painting accessory art, the present disclosure provides a novel painter box system. The general purpose of the present disclosure, which will be described subsequently in greater detail, is to provide a storage and convenience tool for painters.

A painter box system is disclosed herein. The painter box system includes a housing having a top-surface, a first-wall, a second-wall, a third-wall, a fourth-wall, a base, a hollow inner volume, a plurality of legs, a paint-receptacle and a lid. The housing is defined by the top-surface, the first-wall the second-wall, the third-wall, the fourth-wall, the base, the hollow inner volume, the plurality of legs, and the paint-receptacle. The first-wall and the third-wall are generally parallel to each other and the second-wall and the fourth-wall are generally parallel to each other forming the housing. The second-wall and the fourth-wall preferably comprise a greater width apart from each other than the first-wall and the third-wall. The housing comprises a substantially 3-D rectangular profile. The substantially 3-D rectangular profile is tapered. The base of the housing has a greater length and base-width than the top-surface. The housing is configured to be stackable (effectively nestable) for convenient storage minimizing storage space needed. The plurality of legs are positioned at the base. The paint-receptacle is positioned and integral to the top-surface. The painter box system is configured to provide a work platform and support paint within the paint-receptacle in a readily accessible position for use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a painter box system, constructed and operative according to the teachings of the present disclosure.

FIG. 1 is a perspective view of the painter box system during an ‘in-use’ condition, according to an embodiment of the disclosure.

FIG. 2 is a perspective view of the painter box system of FIG. 1, according to an embodiment of the present disclosure.

FIG. 3 is a perspective view of the painter box system of FIG. 1, according to an embodiment of the present disclosure.

FIG. 4 is a perspective view of the painter box system of FIG. 1, according to an embodiment of the present disclosure.

FIG. 5 is a perspective view of the painter box system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a paint accessory and more particularly to a painter box system as used to improve the painting tools.

Generally, the device is a storage and convenience tool for painters having a housing defined by a top-surface, a first-wall, a second-wall, a third-wall, a fourth-wall, a base, a hollow inner volume, a plurality of legs, a paint-receptacle and a lid. The housing is stackable, durable with handles and legs for stability and easy storage. Built into the top of the housing is the paint-receptacle providing a painter's palette tray for allowing easy access to a paint supply. This device can also be stored on site at commercial construction sites for reduced equipment transport as well as simple and easy clean-up. The device may include a lid for storing paint between uses.

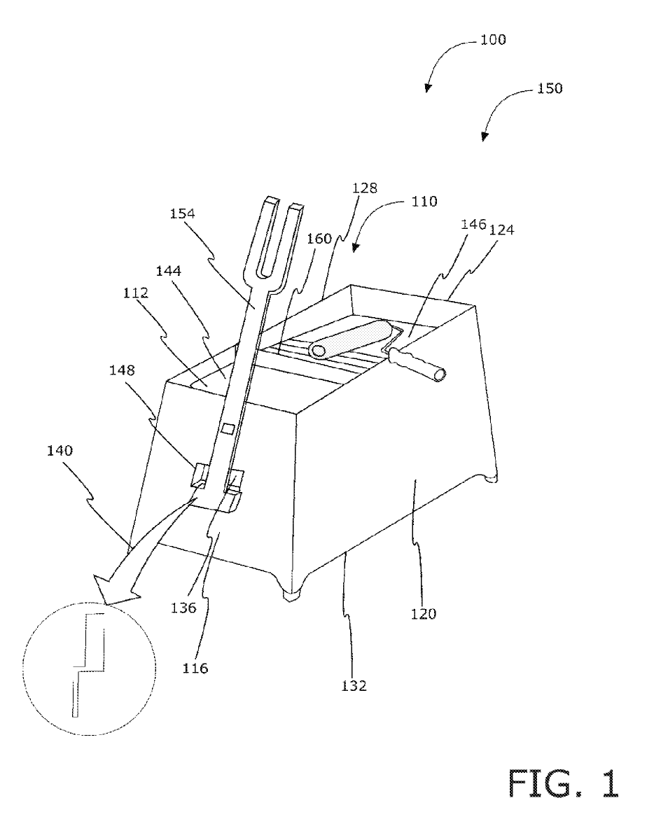

Referring now more specifically to the drawings by numerals of reference, there is shown in FIGS. 1-5, various views of a painter box system 100. FIG. 1 shows a painter box system 100 during an ‘in-use’ condition 150, according to an embodiment of the present disclosure. As illustrated, the painter box system 100 may include a housing 110 having a top-surface 112, a first-wall 116, a second-wall 120, a third-wall 124, a fourth-wall 128, a base 132, a hollow inner volume 136, a plurality of legs 140, a paint-receptacle 144 and a lid 158. The device provides a portable work surface for supporting paint at a convenient height within the paint-receptacle 144 for easy access to the paint while painting. A roller handle stand 154 may also be included and configured to provide a convenient storage rack for a roller. The roller handle stand 154 may be attached to a handle 148 of the housing 110 and extend upwardly from a side of the housing 110. Two prong members may be located on the distal end of the roller handle stand 154.

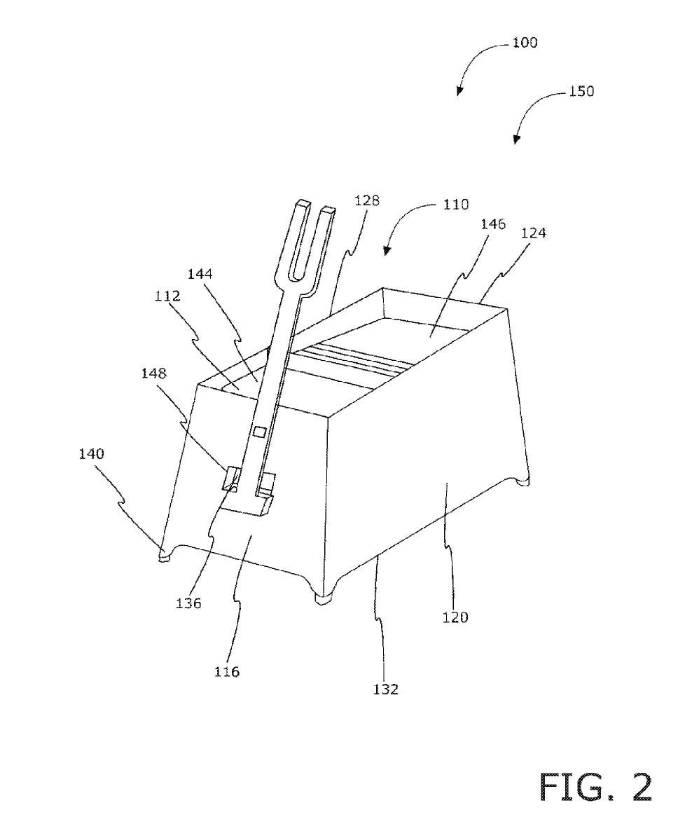

FIG. 2 shows a perspective view of the painter box system 100 of FIG. 1, according to an embodiment of the present disclosure. As above, the painter box system 100 may include the housing 110 having the top-surface 112, the first-wall 116, the second-wall 120, the third-wall 124, the fourth-wall 128, the base 132, the hollow inner volume 136, the plurality of legs 140, and the paint-receptacle 144 in functional combination. The housing 110 is defined by the top-surface 112, the first-wall 116, the second-wall 120, the third-wall 124, the fourth-wall 128, the base 132, the hollow inner volume 136, the plurality of legs 140, the paint-receptacle 144, and the lid 158. The first-wall 116 and the third-wall 124 are generally parallel to each other and the second-wall 120 and the fourth-wall 128 are generally parallel to each other forming the housing 110. The second-wall 120 and the fourth-wall 128 comprise a greater width apart from each other than the first-wall 116 and the third-wall 124 creating a substantially 3-D rectangular profile. The plurality of legs 140 are positioned at the base 132. The paint-receptacle 144 is positioned and integral to the top-surface 112. The painter box system 100 is configured to provide a work platform and support paint within the paint-receptacle 144 in a readily accessible position for use.

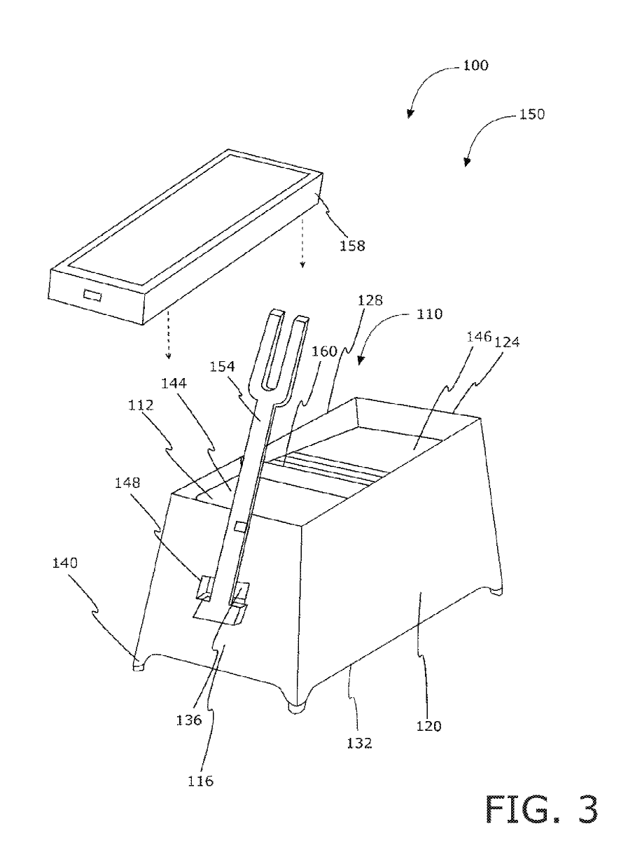

FIG. 3 shows a perspective view of the painter box system 100 of FIG. 1, according to an embodiment of the present disclosure. As above, the painter box system 100 may include the housing 110. The housing 110 comprises a substantially 3-D rectangular profile. The substantially 3-D rectangular profile is tapered. The base 132 of the housing 110 has a greater length and base-width than the top-surface 112. The housing 110 is configured to be stackable allowing the device to be conveniently stored on site without taking up additional storage space. The housing 110 is rigid providing a sturdy work surface. In a preferred embodiment, the housing 110 includes at least one handle 148. The at least one handle 148 is positioned on the first-wall 116 and the third-wall 124. In a preferred embodiment, a height of the housing 110 is approximately 20 inches, a length of the housing 110 is approximately 24 inches, and a width of the housing 110 is approximately 14 inches.

Also referring to FIG. 3, there is shown a lid 158. The lid 158 may be included with the housing 110 and is configured to contain paint for a later use and also provide a work platform step. The lid 158 may be used as a step when applied to the top-surface 112 of the housing 110. The lid 158 when attached to the housing 110 provides a suitable height and work surface for working and painting. The lid 158 may include a textured top surface. In a preferred embodiment, the dimensions of the lid 158 are approximately 14⅛ inches wide and 24⅛ inches long or a suitable size to match the housing 110.

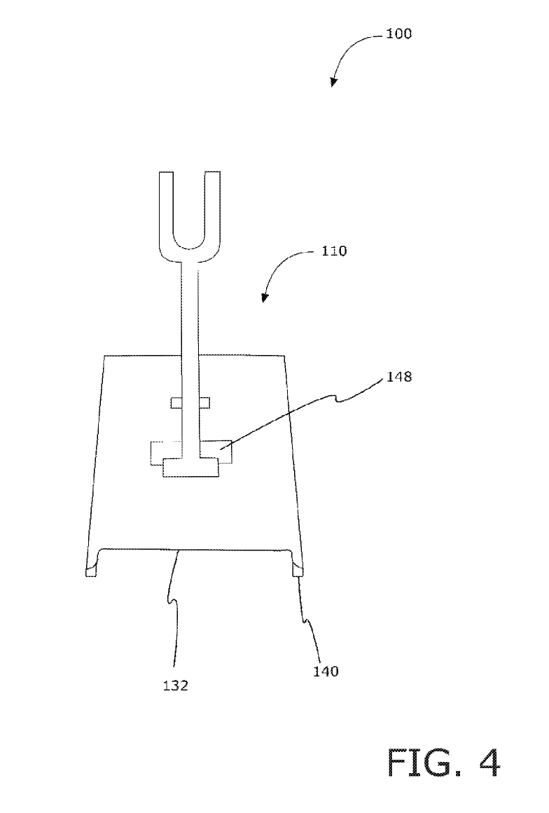

FIG. 4 shows a perspective view of the painter box system 100 of FIG. 1, according to an embodiment of the present disclosure. As above, the painter box system 100 may include the housing 110 having the top-surface 112, the first-wall 116, the second-wall 120, the third-wall 124, the fourth-wall 128, the base 132, the hollow inner volume 136, the plurality of legs 140, the paint-receptacle 144 and the lid 158. The plurality of legs 140 each comprise a textured bottom-surface for increasing friction with a ground surface and prevent unwanted relative movement. The textured bottom-surface comprises rubber feet or other suitably equivalent material. In a preferred embodiment, the housing 110 comprises four of the plurality of legs 140.

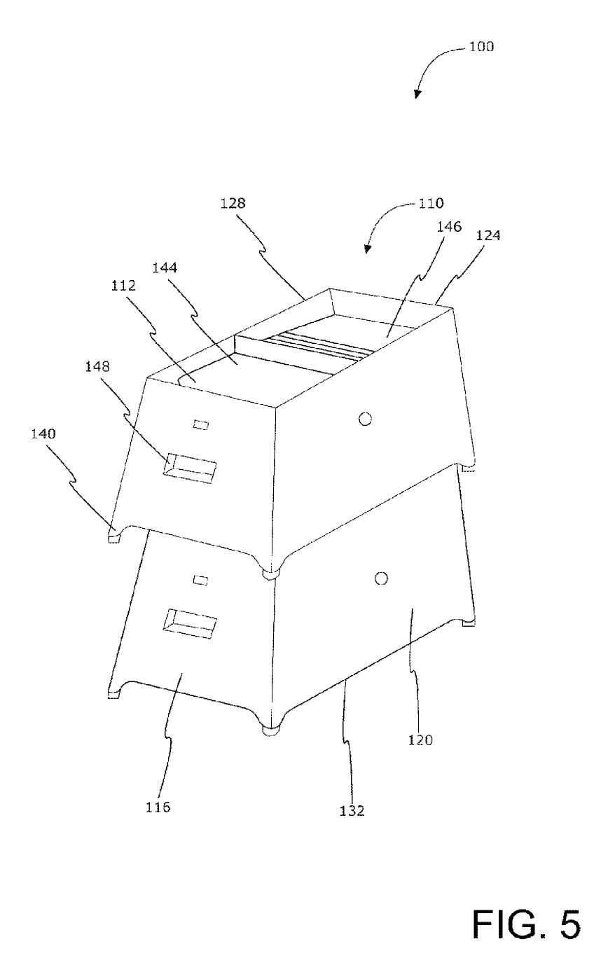

FIG. 5 shows a perspective view of the painter box system 100 of FIG. 1, according to an embodiment of the present disclosure. As above, the painter box system 100 may include the housing 110 having the top-surface 112, the first-wall 116, the second-wall 120, the third-wall 124, the fourth-wall 128, the base 132, the hollow inner volume 136, the plurality of legs 140, the paint-receptacle 144 and the lid 158. The paint-receptacle 144 is tapered having a deep end and a shallow end for using a paint roller or brush within. The top-surface 112 may further comprise a compartment divider 160 dividing the paint-receptacle 144 from a storage compartment. The paint-receptacle 144 comprises a paint-receptacle-inner-volume 146 and a series of riffles deeper than a standard factory tray. The paint-receptacle-inner-volume 146 is non-flush with an outer edge of the top-surface 112. The base 132 may be elevated off a planar surface via the plurality of legs 140. The paint-receptacle 144 is defined and confined by the first-wall 116, the second-wall 120, the third-wall 124, and the fourth-wall 128. The paint-receptacle 144 and the housing 110 are integral; the paint-receptacle 144 formed in the housing 110. The device may be used in a method of use including providing the device, filling paint-receptacle with paint, positioning the device and using the device for painting surfaces (the device may also be used with a ladder).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A painter box system comprising:
a housing having;
a top-surface;
a first-wall;
a second-wall;
a third-wall;
a fourth-wall;
a base;
a hollow inner volume;
a plurality of legs;
a paint-receptacle; and
a lid.
wherein said housing is defined by said top-surface, said first-wall said second-wall, said third-wall, said fourth-wall, said base, said hollow inner volume, said plurality of legs, said paint-receptacle, and a lid;
wherein said first-wall and said third-wall are generally parallel to each other and said second-wall and said fourth-wall are generally parallel to each other forming said housing;
wherein said second-wall and said fourth-wall comprise a greater width apart from each other than said first-wall and said third-wall;
wherein said plurality of legs are positioned at said base;
wherein said paint-receptacle is positioned and integral to said top-surface; and
wherein said painter box system is configured to provide a work platform and support paint within said paint-receptacle in a readily accessible position for use.

2. The painter box system of claim 1, wherein said housing comprises a substantially 3-D rectangular profile.

3. The painter box system of claim 2, wherein said substantially 3-D rectangular profile is tapered.

4. The painter box system of claim 3, wherein said base of said housing has a greater length and base-width than said top-surface.

5. The painter box system of claim 4, wherein said housing is configured to be stackable.

6. The painter box system of claim 1, wherein said painter box system further comprises a roller handle stand configured to attached to a handle.

7. The painter box system of claim 1, wherein said housing comprises at least one handle.

8. The painter box system of claim 7, wherein said at least one handle is positioned on said first-wall and said third-wall.

9. The painter box system of claim 1, wherein said plurality of legs each comprise a textured bottom-surface for increasing friction with a ground surface and prevent unwanted relative movement.

10. The painter box system of claim 1, wherein said textured bottom-surface comprises rubber feet.

11. The painter box system of claim 1, wherein said housing comprises four of said plurality of legs.

12. The painter box system of claim 1, wherein a height of said housing is approximately 20 inches.

13. The painter box system of claim 12, wherein a length of said housing is approximately 24 inches.

14. The painter box system of claim 13, wherein a width of said housing is approximately 14 inches.

15. The painter box system of claim 1, wherein said paint-receptacle further comprises a compartment divider.

16. The painter box system of claim 1, wherein said paint-receptacle comprises a paint-receptacle-inner-volume, said paint-receptacle-inner-volume is non-flush with an outer edge of said top-surface.

17. The painter box system of claim 1, wherein said base is elevated off a planar surface via said plurality of legs.

18. The painter box system of claim 1, wherein said paint-receptacle is defined and confined by said first-wall said second-wall, said third-wall, and said fourth-wall.

19. The painter box system of claim 1, wherein the paint-receptacle and the housing are integral, the paint-receptacle formed in the housing.

20. A painter box system, the painter box system comprising:
a housing having;
a top-surface;
a first-wall;
a second-wall;
a third-wall;
a fourth-wall;
a base;
a hollow inner volume;
a plurality of legs;
a paint-receptacle; and
a lid;
wherein said housing is defined by said top-surface, said first-wall said second-wall, said third-wall, said fourth-wall, said base, said hollow inner volume, said plurality of legs, said paint-receptacle, and a lid;
wherein said first-wall and said third-wall are generally parallel to each other and said second-wall and said fourth-wall are generally parallel to each other forming said housing;
wherein said second-wall and said fourth-wall comprise a greater width apart from each other than said first-wall and said third-wall;
wherein a height of said housing is approximately 20 inches;
wherein a length of said housing is approximately 24 inches;
wherein a width of said housing is approximately 14 inches;
wherein said housing comprises a substantially 3-D rectangular profile;
wherein said substantially 3-D rectangular profile is tapered;
wherein said base of said housing has a greater length and base-width than said top-surface;
wherein said housing is configured to be stackable;
wherein said wherein said painter box system further comprises a roller handle stand configured to attached to a handle;
wherein said housing comprises at least one handle;
wherein said at least one handle is positioned on said first-wall and said third-wall;
wherein said housing comprises four of said plurality of legs;
wherein said plurality of legs are positioned at said base;
wherein said base is elevated off a planar surface via said plurality of legs;
wherein said plurality of legs each comprise a textured bottom-surface for increasing friction with a ground surface and prevent unwanted relative movement;
wherein said textured bottom-surface comprises rubber feet;
wherein said paint-receptacle is positioned and integral to said top-surface;
wherein said paint-receptacle further comprises a compartment divider;
wherein said paint-receptacle comprises a paint-receptacle-inner-volume, said paint-receptacle-inner-volume is non-flush with an outer edge of said top-surface;
wherein said paint-receptacle is defined and confined by said first-wall said second-wall, said third-wall, and said fourth-wall;
wherein the paint-receptacle and the housing are integral, the paint-receptacle formed in the housing; and
wherein said painter box system is configured to provide a work platform and support paint within said paint-receptacle in a readily accessible position for use.
